(19) United States
(12) Patent Application Publication
(10) Pub. No.: US 2007/0064365 A1
(43) Pub. Date: Mar. 22, 2007

(54) Circuit arrangement for rapidly switching off low-voltage power breakers

(76) Inventors: Clifford A. Buxton, Bellefontaine, OH (US); Marc Liebetruth, Glienicke (DE); Klaus Neidhardt, Berlin (DE); Andreas Pancke, Berlin (DE); Wolfgang Röhl, Berlin (DE)

Correspondence Address: HARNESS, DICKEY & PIERCE, P.L.C., P.O.BOX 8910, RESTON, VA, 20195, US

(21) Appl. No.: 10/571,564

(22) PCT Filed: Aug. 24, 2004
(86) PCT No.: PCT/DE04/01908

§ 371 Date: Mar. 10, 2006

(30) Foreign Application Priority Data
Sep. 12, 2003 (DE) 103 43 339.2

(51) Int. Cl. H02H 3/08

(52) U.S. Cl. 361/93.1

(57) ABSTRACT

A circuit arrangement is disclosed for rapidly switching off low-voltage circuit breakers comprising an electronic tripping unit. According to an embodiment, a switching element which is operated in a short-circuit mode during normal operation and to which a fast trip magnet of the low-voltage circuit breaker is connected in parallel is impinged upon by a current that is proportionate to the current monitored by the low-voltage circuit breaker, and the short circuit of the switching element is bypassed when the current monitored by the low-voltage circuit breaker reaches a set threshold value. One respective transformer is serially connected to the power inputs of the electronic tripping unit, the secondary ends of the transformers being interconnected among each other on the direct voltage side while being serially connected to the switching element via bridge rectifiers.

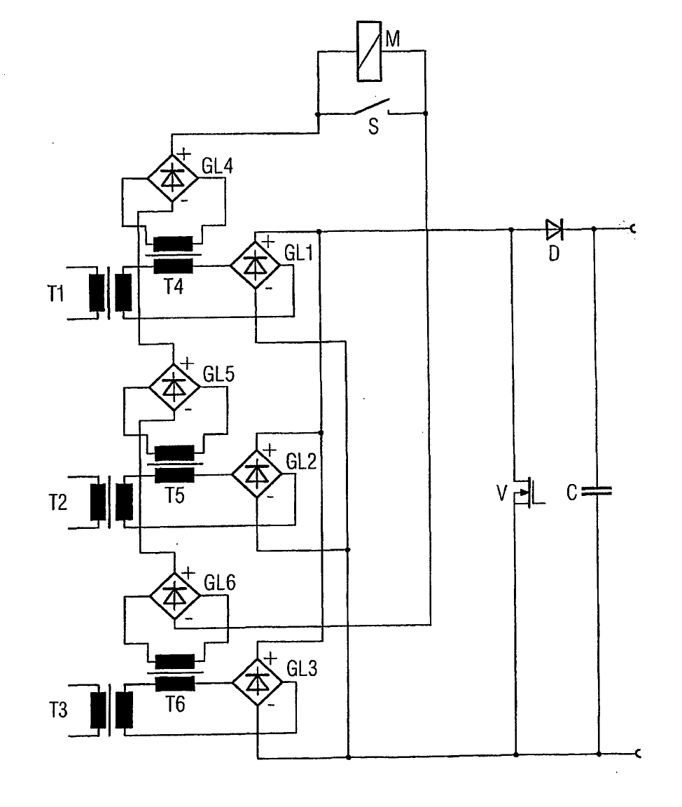

This application is the national phase under 35 U.S.C. § 371 of PCT International Application No. PCT/DE2004/001908 which has an International filing date of Aug. 24, 2004, which designated the United States of America and which claims priority on German Patent Application number 103 43 339.2 filed Sep. 12, 2003, the entire contents of which are hereby incorporated herein by reference.

### FIELD

The invention generally relates to a circuit arrangement. For example, it may relate to an arrangement for rapidly tripping low-voltage power circuit breakers having an electronic tripping unit by a switching element, operated in the short circuit during normal operation and connected in parallel with a rapid-response tripping magnet of the low-voltage power circuit breaker, having a current applied to it which is proportional to the current monitored by the low-voltage power breaker, and the short circuit across this switching element being cancelled if the current monitored by the low-voltage power circuit breaker reaches a fixed threshold value.

### BACKGROUND

In the case of high currents, for example owing to a short circuit in the power supply system, even undelayed tripping of a low-voltage power circuit breaker may still be too slow since the signal processing in the microprocessor of the electronic release requires a certain amount of time. In the case of low-voltage power circuit breakers in which the power for the tripping unit is drawn from the power supply system itself via further current transformers and rectifiers, when the power circuit breaker is first used there is also not yet any power available for as long as an associated charging capacitor has not yet been charged.

It has therefore already been proposed, in the event that a high current is detected in the power supply system, to allow this high current to commutate directly onto the tripping magnet of the power breaker. For this purpose, the secondary sides of the current transformers provided for the supply of power to the tripping unit are connected to the tripping unit via bridge rectifiers and via a short-circuit path of a switching element. The rapid-response tripping magnet is connected in parallel with the switching element, for example a reed relay, a transistor, driven from a uniform-field coil, a field sensor or the like, and is short-circuited during normal operation. Only at high short-circuit currents in the power supply system, for example 35 kA, does the parallel short-circuit path open such that the rapid-response tripping magnet is activated.

The circuit requires intervention in the current path of the tripping unit and is therefore not suitable for retrofitting existing systems.

### SUMMARY

At least one embodiment of the invention includes an object of specifying a circuit arrangement for rapidly tripping low-voltage power circuit breakers which is also suitable for retrofitting. The power supply should also come from the previously used power transformers. No changes should be made to the electronic tripping unit.

Accordingly, in at least one embodiment, in each case one transformer is connected in series with the current inputs of the electronic tripping unit. The secondary sides of these transformers are connected in series with one another on the DC voltage side via bridge rectifiers and with the switching element. The rapid-response tripping magnet, which is connected in parallel with the switching element, is (as is known) short-circuited during normal operation with the parallel short-circuit path of the switching element. Only at high short-circuit currents in the power supply system does the parallel short-circuit path open such that the rapid-response tripping magnet is activated.

The transformers provide the required electrical isolation and may have a transformation ratio of 1:1, for example.

The circuit can be retrofitted at any time in switches of existing switchgear assemblies. As the previously known circuit for rapidly tripping a low-voltage power circuit breaker, it has the advantage that, in the event of a short circuit in the monitored power supply system, tripping takes place very rapidly and even when the power circuit breaker switches to a short circuit when it is closed.

### BRIEF DESCRIPTION OF THE DRAWINGS

Embodiments of the invention will be explained in more detail below by way of example with reference to the detailed description and drawing.

The drawing shows a block diagram of the circuit arrangement according to at least one embodiment of the invention.

### DETAILED DESCRIPTION OF THE EXAMPLE EMBODIMENTS

The drawing schematically illustrates part of an electronic tripping unit for a low-voltage power circuit breaker on a three-phase power supply system. The secondary sides of current transformers T1, T2, T3 form, together with bridge rectifiers GL1, GL2, GL3, the power supply for an electronic release (not shown in any more detail here) . The DC voltage outputs of the bridge rectifiers GL1, GL2, GL3 are connected in parallel and lead to a charging capacitor C. The voltage across the charging capacitor C is regulated by a switching transistor V. A diode D prevents the charging capacitor C from discharging when the switching transistor V is driven. The charging capacitor C ensures that the operation of the downstream release is maintained even in the case of interruptions to the current or short-term low currents in the power supply system.

In each case one transformer T4, T5, T6 is connected in series with the current inputs of the electronic tripping unit. The secondary sides of these transformers T4, T5, T6 are connected in series with one another on the DC voltage side via bridge rectifiers GL4, GL5, GL6 and with a switching element S. As is known, a rapid-response tripping magnet M of the associated low-voltage power circuit breaker is arranged in parallel with the switching element S.

The switching element S (shown merely schematically here) may be a reed relay, a transistor, a field sensor or the like. It is short-circuited during normal operation or is operated in the short circuit. The switching element S is driven by the tripping circuit, for example a drive circuit (not shown here) for a switching transistor, which represents the switching element S.

In the event of a predetermined response value being exceeded, the short circuit of the switching element S is cancelled and the current commutates to the tripping magnet M, which causes the low-voltage power circuit breaker to be tripped rapidly.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A circuit arrangement for rapidly tripping a low-voltage power circuit breaker having an electronic tripping unit, including a switching element, operated in a short circuit mode during normal operation and connected in parallel with a rapid-response tripping magnet of the low-voltage power breaker, including a current, applied thereto, proportional to the current monitored by the low-voltage power breaker, and a monitoring circuit for the current monitored by the low-voltage power breaker, used to cancel the short circuit across the switching element when a fixed threshold value is reached, the circuit arrangement comprising:
a plurality of transformers, each respective transformer connected in series with a respective one of the current inputs of the electronic tripping unit, the secondary sides of said transformers being connected in series with one another on the DC voltage side via bridge rectifiers, and connected with the switching element.

2. The circuit arrangement as claimed in claim 1, wherein
the transformers include a transformation ratio of 1:1.

3. A circuit arrangement for a power circuit breaker, comprising:
a switching element, operated in a short circuit mode during normal operation and connected to a tripping magnet of the low-voltage power breaker, a current, proportional to the current monitored by the low-voltage power breaker, adapted to impinge upon the switching element;
a monitoring circuit to cancel the short circuit across the switching element when a threshold value is reached; and
a plurality of transformers, each respectively connected in series with a respective one of the current inputs of the electronic tripping unit, the secondary sides of the transformers being inter-connected among each other on the DC voltage side, and being serially connected to the switching element via bridge rectifiers.

4. The circuit arrangement as claimed in claim 3, wherein the transformers include a transformation ratio of 1:1.
